(19) United States
(12) Patent Application Publication
(10) Pub. No.: US 2006/0219104 A1
(43) Pub. Date: Oct. 5, 2006

(54) Cotton packager with interior wall including hold down elements for holding cotton in a compacted state

(75) Inventors: Michael J. Covington, Bettendorf, IA (US); Darryl Pasket, Anderson, TX (US); Kevin S. Richman, Sherrard, IL (US)

Correspondence Address: CNH AMERICA LLC, INTELLECTUAL PROPERTY LAW DEPARTMENT, 700 STATE STREET, RACINE, WI, 53404, US

(73) Assignee: CNH America LLC

(21) Appl. No.: 11/096,995

(22) Filed: Apr. 1, 2005

(51) Int. Cl. B30B 15/00

(52) U.S. Cl. 100/220

(57) ABSTRACT

Hold down elements for interior walls in a cotton compacting chamber of a cotton packager, which facilitate holding or retaining compacted cotton in a compacted state in the chamber, without significantly interfering with or restricting unloading of a cotton module from the chamber, or reducing structural integrity of the module. One or more of the hold down elements can be utilized on an interior wall, and the hold down elements are oriented so as to extend longitudinally in an unloading direction, such that a cotton module will slide therealong without being held in the chamber by the hold down element.

### TECHNICAL FIELD

This invention relates generally to a packager for a cotton harvesting machine, and more particularly, to a cotton packager interior wall including hold down elements for holding or retaining cotton in a compacted state, which does not interfere with removal of the compacted cotton from the packager.

### BACKGROUND ART

Cotton harvesting machines commonly now include an on-board cotton module builder or packager having interior walls defining a compacting or packaging chamber in which harvested cotton is collected and compacted by compacting apparatus into a unitary mass or module. Such compacted modules are desirably sufficiently compacted so as to retain their compacted shape when removed from the compacting chamber for ease of handling and other purposes.

When compacting cotton into a unitary cotton module, the density of the packed cotton achievable is a function of the amount of cotton that can be harvested to fill the chamber, and the packing characteristics of the cotton. The higher the moisture content of the cotton being harvested, generally the better it will pack and therefore the higher the amount of cotton that can be compacted into a cotton module. However, a moisture content that is too high can be detrimental as it can increase heat build-up in the module, and can be more difficult to gin. As a result, it is desirable to harvest cotton when the moisture content is generally 12% or below. Typically, cotton being harvested will have varying moisture contents as some of the cotton will have been ready to harvest for some time, and some of the cotton will have just become suitable for harvest. Also, cotton will typically have a higher moisture content in the morning and later in the day, compared to in the middle of the day. Moisture content can also vary in different cotton varieties. Further, when the moisture content and harvested cotton is low, typically below 5% , the cotton has a tendency to have sponge-like characteristics when packed. That is, when compacted downwardly by compactor apparatus of the packager, dry cotton having a moisture content of generally below 5% will have a tendency to spring upwardly back toward its original, uncompacted height, faster than cotton with a higher moisture content. As a result of this faster springback characteristic, the area of the compacting chamber above the compacted cotton and below the compactor apparatus when in a retracted, raised state, is smaller, compared to when the compacted cotton has a lower springback characteristic. The effect is that the packager must be unloaded more frequently, which is a disadvantage productivity wise. It is thus desirable to have a means for better holding or retaining compacted cotton in a compacted state in the compacting chamber of a packager, to increase the capacity thereof, and extend the period between unloadings.

Packagers typically have one end or side which includes an unloader door which is opened to allow removal of a compacted cotton module from the compacting chamber. A typical completed cotton module can be about 16 feet long and from about 7 to about 9 feet in width and height. A completed cotton module can weigh as much as 11,000 pounds. Accordingly, any means for limiting springback or holding or retaining cotton in a compacted state in a compacting chamber should not interfere with, or increase difficulty of, removal of a cotton module from the chamber.

Thus, what is sought is apparatus for interior walls of a cotton packager adapted for holding or retaining compacted cotton in a compacted state, yet which avoids one or more of the problems and shortcomings set forth above, particularly, which does not interfere with removal of a compacted body of cotton from a cotton packager.

### SUMMARY OF THE INVENTION

What is disclosed is hold down elements for an interior wall in a cotton compacting chamber of a cotton packager, which facilitate holding or retaining compacted cotton in a compacted state in the chamber, without significantly interfering with or restricting unloading of a cotton module or suffering from other disadvantages discussed above.

According to a preferred aspect of the invention, the cotton compacting chamber of the packager includes a first or unloading end, and an enclosed second end. A floor defines the bottom of the chamber and extends between the ends, and side walls extend upwardly from the floor in opposing relation between the opposite ends. A door encloses the first end and is openable for unloading the cotton from the chamber. An end wall extends upwardly from the floor between the side walls at the second end of the chamber. Compacting apparatus is disposed above or in an upper region of the chamber and is movable downwardly into the chamber under pressure for compacting cotton in the chamber into a compacted mass or module having a shape and extent defined by the opposing side walls, end wall and door. Advantageously, at least one of the opposing side walls includes at least one elongate hold down element which extends from the wall into the chamber and longitudinally between the first and second ends, for holding or retaining compacted cotton in, or close to, a state as compacted by the compacting apparatus.

As a result, the compacted cotton has less of a tendency to spring upwardly from the compacted state and occupy a greater portion of the chamber, such that more of the chamber is open for receiving additional cotton therein.

According to a preferred aspect of the invention, each of the side walls includes a plurality of the elongate hold down elements extending between the opposite ends of the chamber in a vertically spaced array, for holding or retaining cotton in a compacted state adjacent both sides of the chamber. When it is desired to remove the compacted cotton module from the chamber, the door is opened and since the elongate hold down elements are oriented to extend in the direction for removal of the module toward the door, they present no significant impediment to removal of the module.

### BRIEF DESCRIPTION OF THE DRAWINGS

FIG. 1 is a side view of a cotton harvesting machine including a cotton packager having hold down elements on interior walls thereof for holding cotton in a compacted state according to the invention;

FIG. 2 is an enlarged end view of the packager of FIG. 1 with an unloader door thereof removed to show interior side walls of the packager and the hold down elements of the invention thereon for holding cotton in a compacted state;

FIG. 3 is an enlarged fragmentary end view of the packager, showing the hold down elements on one of the side walls;

FIG. 4 is another fragmentary end view of the packager, showing a hold down element on one of the side walls holding compacted cotton as contemplated according to the invention;

FIG. 5 is a fragmentary end view of the packager showing an alternative embodiment of hold down elements for holding cotton in a compacted state according to the invention; and

FIG. 6 is another fragmentary end view of the packager of FIG. 5, showing a hold down element on the side wall holding cotton as contemplated according to the invention.

### DETAILED DESCRIPTION OF THE INVENTION

A representation conventional cotton harvesting machine 10 is shown, including a cotton packager 12 for receiving and holding cotton harvested by a plurality of picker units 14 arrayed across a forward end of machine 10. The cotton is conveyed from picker units 14 through a plurality of parallel ducts 16 by air flows through the ducts.

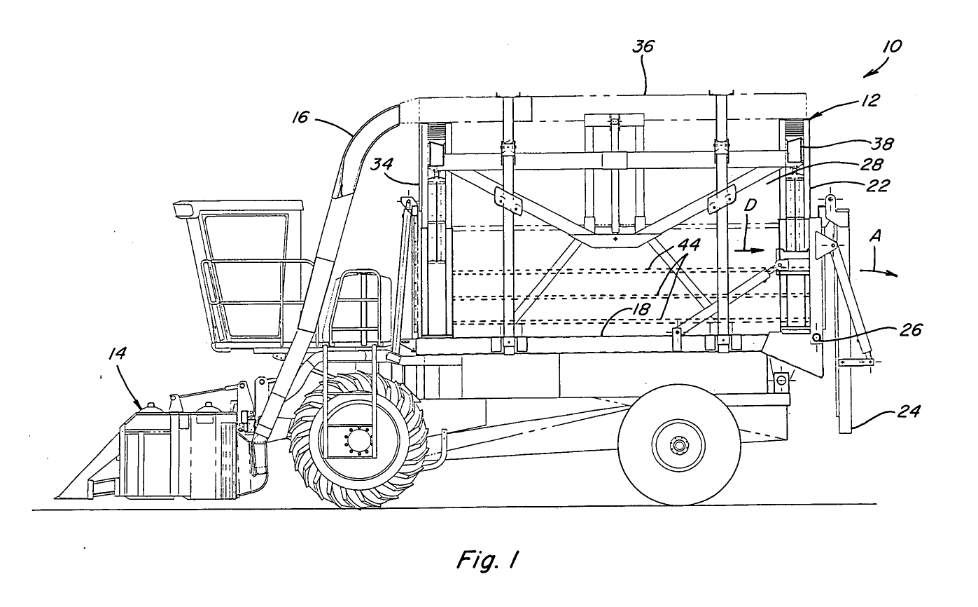

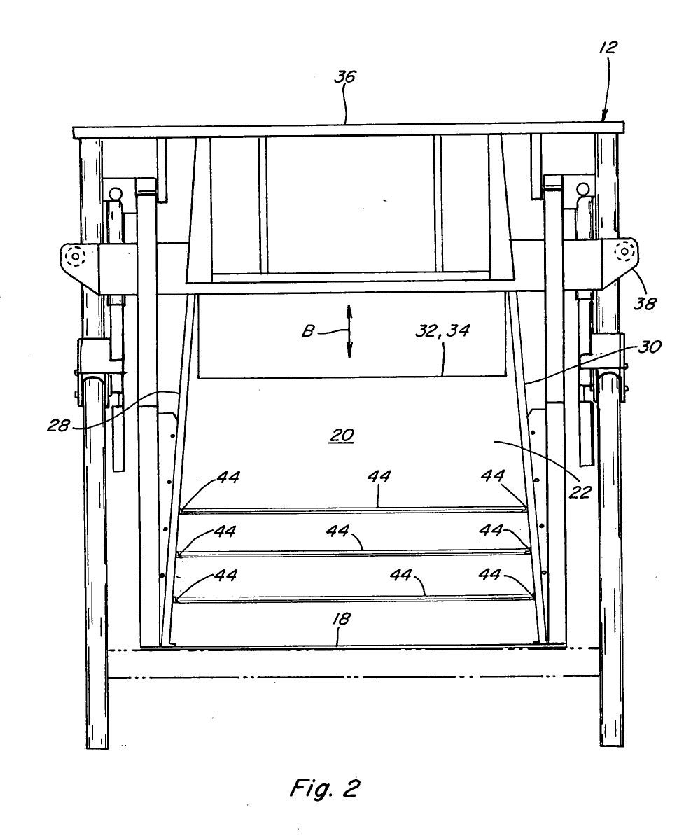

Referring also to FIG. 2, packager 12 of machine 10 includes a floor 18 which defines the bottom of a cotton compacting chamber 20. Chamber 20 includes a first end 22 enclosable by a door 24 (FIG. 1) which is pivotally mounted at a pivot 26 for movement in a direction A to an open position to allow unloading of cotton from chamber 20. A pair of opposing side walls 28 and 30 extend upwardly from floor 18 on opposite sides of chamber 20 between first end 22, and an opposite second end 32 enclosed by an end wall 34. An upper region of chamber 20 is enclosed by a roof 36, and contains compacting apparatus 38 supported for upward and downward movement, as denoted by arrow B, for compacting cotton in chamber 20 against floor 18, door 24, side walls 28 and 30, and end wall 34, in the well known manner.

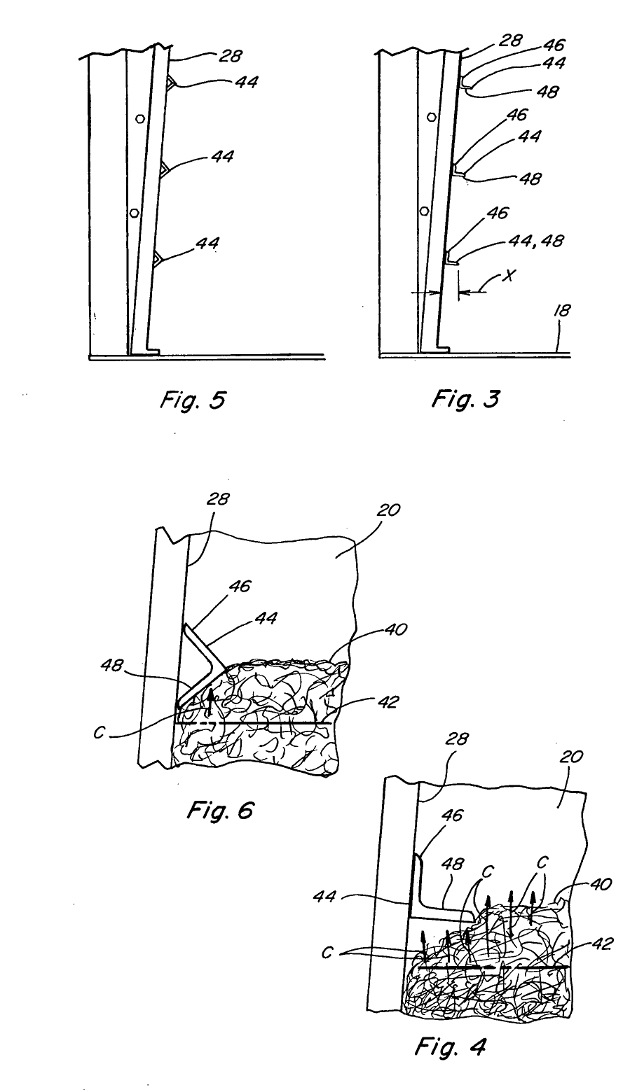

Referring more particularly to FIG. 2, and also to FIGS. 3 and 4, side walls 28 and 30 are each tapered so as to extend convergingly toward the upper ends thereof away from floor 18. The upward and downward taper can be advantageous as cotton compacted into a unitary body or module will tend to take the shape of the chamber, and thus, the upward and downward taper of side walls 28 and 30 will impart a corresponding upward and downward taper to the sides of a cotton module formed therein. Then, when the module is removed from chamber 20, and no longer restrained by side walls 28 and 30, the natural springiness of the cotton will typically cause the module to expand to a more rectangular shape.

Compaction of the cotton in chamber 20 by compacting apparatus 38 is typically done at intervals during a harvesting operation. Compacting typically entails lowering apparatus 38 to a height just above collected cotton in chamber 20, then repeatedly driving apparatus 38 downwardly against the cotton to compact it against floor 18, side walls 28 and 30, end wall 34, and door 24. Referring more particularly to FIG. 4, a compacted body of cotton 40 is illustrated in chamber 20. A line of compaction 42 is shown extending generally horizontally through body of cotton 40. Line 42 represents a downward extent of travel of compacting apparatus 38 (FIGS. 1 and 2) against body of cotton 40, and line 42 thus represents the height of the compacted body immediately after compaction by compacting apparatus 38. Due to the springiness of the cotton, discussed in the Background section above, resulting from moisture content and other conditions thereof, compacted body of cotton 40 will be expected to spring back in the upward direction, as represented by upwardly directed arrows C. Such upward springing of the cotton is generally disadvantageous, as it decreases the volume or space of chamber 20 between compacted body of cotton 40 and compacting apparatus 38 disposed thereabove for receiving incoming cotton. It is thus desirable to have a means of restraining the upward spring back of the cotton, to maintain as much interior volume of chamber 20 as possible for receiving the incoming cotton. However, any such restraint should not interfere with the upward and downward movement of compacting apparatus 38, nor should it make unloading the cotton from chamber 20 more difficult. It has been found that restraining upper movement of the cotton adjacent to the sides of chamber 20 can act to limit upward movement of cotton throughout the length and width of compacted body of cotton 40 satisfactorily for limiting reduction in the interior volume of chamber 20 resulting from spring back.

According to a preferred aspect of the invention, elongate hold down elements 44 are disposed on side walls 28 and 30 so as to extend or project inwardly into chamber 20 along a substantial portion or all of the forward to rearward length thereof at spaced locations along the height thereof, for restraining and holding the sides of a compacted body of cotton 40 down, for significantly restricting upward spring back or expansion thereof after compaction by compacting apparatus 38. Importantly, hold down elements 44 are oriented to extend in substantial parallel relation to floor 18 frontwardly and rearwardly, so as to be aligned with a direction of travel of a compacted body of cotton, such as body 40, when removed from chamber 20, which direction is denoted by arrow D in FIG. 1, such that the body of cotton can move smoothly in direction D along hold down elements 44 and elements 44 will not act to hold the body of cotton in chamber 20, or snag or otherwise result in significant damage to the body of cotton during removal. End wall 34 also optionally includes additional elongate hold down elements 44 in similar elevational positions thereon, as shown.

Here, each elongate hold down element 44 preferably has an angled or L-shape, one leg 46 of which can be suitably mounted to the wall from which element 44 extends, such as by welding, or using common fasteners such as bolts or rivets, or adhesives, such that a leg 48 of element 44 extends or projects into chamber 20 similarly to the manner shown. Because side walls 28 and 30 taper convergingly in the upward direction, legs 48 are angled so as to extend slightly downwardly toward the distal end thereof along the length thereof, which can be advantageous for holding the compacted cotton down. Referring more particularly to compacted body of cotton 40 in FIG. 4, as a result of normal spring back it is anticipated that in the absence of element 44, the upper extent of body of cotton 40 would be some distance higher than that shown.

Here also, it should be noted that hold down elements 44 extend only a short distance, typically anticipated to be less than 1.5 inches or less, into cotton compacting chamber 20. That portion of hold down element 44 which extends into chamber 20, which here is leg 48, is additionally relatively narrow in sectional extent, that is, vertically as illustrated. These characteristics can be advantageous as they provide the desired or required restraint of spring back, but do not extend sufficiently into a body of cotton compacted around the hold down element, so as to significantly reduce the volume of a compacted body of cotton, or the strength or integrity of the sides of the compacted body of cotton when removed from chamber 20 and left in a freestanding state. Thus, hold down elements 44 according to the present invention achieve the desired hold down function, without significantly interfering with removal of a compacted body of cotton from chamber 20, or significantly reducing the size or structural integrity of the body of cotton. In some instances, it may also be desirable to load a compacted body of cotton into chamber 20, and hold down elements 44 likewise would not interfere with or impede this operation. With this in mind, most preferably, hold down elements 44 extend sidewardly from side walls 28 and 30 by a distance of from about one-half inch to about 1.5 inches or less, as denoted by distance X in FIG. 3. Those portions of hold down elements 44 that extend into chamber 20 will preferably have a sectional extent of no more than a few inches. Also most preferably, hold down elements 44 on opposite side walls 28 and 30 are disposed at about the same heights on the side walls, such that the opposite sides of a cotton module formed in chamber 20 will be held down or restrained in a similar manner. Regarding vertical spacing of adjacent ones of hold down elements 44, spaces of from between about 6 inches and about 18 inches have been found to be satisfactory for cotton modules to have a completed height of from about 7 feet to about 9 feet.

Referring also to FIGS. 5 and 6, an alternative embodiment of elongate hold down elements 44 on side wall 28 is illustrated. Referring more particularly to FIG. 6, distal ends of legs 46 and 48 of element 44 abut side wall 28 such that the proximal or intersecting ends of the legs project into chamber 20. Upward movement of body of cotton 40, denoted by arrow C, will be restrained by contact with the angularly oriented surface of leg 48 of element 40, thereby reducing the upward springing movement of the cotton from the line of compaction 42. Again, hold down elements 44 can be mounted on the walls, such as wall 28, in a suitable manner, such as by welding, or using suitable fasteners, or adhesives, in a manner so as to not significantly interfere with sliding movement of a body of cotton longitudinally along the elements 44 during unloading.

It should be noted that placement of hold down elements 44 at other locations below a line of compaction 42 can have a similar effect for restraining upward spring back of compacted cotton. As an example, it is contemplated that several compacting steps will be involved in the forming of a completed compacted body of cotton, such as body of cotton 40. Thus, the body of cotton can be held down along the height thereof by several hold down elements 44, the lower ones of the elements 44 acting to restrain upward springing of lower regions of the compacted body of cotton, until the weight of additional cotton compacted thereon holds the lower cotton down.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

1. A cotton packager comprising:
a floor, at least a pair of opposing side walls extending upwardly from peripheral edges of the floor defining a cotton compacting chamber, and a door enclosing an end of the chamber;
compacting apparatus disposed above or in an upper region of the chamber for movement downwardly into the chamber for compacting cotton therein into a compacted body having a shape and sideward extent at least generally defined by the opposing side walls, the door being openable to allow removal of a compacted body of cotton from the chamber through the end; and
at least one elongate hold down element disposed on at least one of the side walls along a substantial portion thereof, the hold down element extending from the side wall into the chamber longitudinally in substantially parallel relation to the floor, for limiting upward spring back of cotton compacted by the compacting apparatus.

2. The packager of claim 1, wherein the hold down element has an L-shape including a leg which extends into the chamber.

3. The packager of claim 1, wherein each of the side walls include a plurality of the elongate hold down elements extending therealong in a vertically spaced array in substantially parallel relation to the floor.

4. The packager of claim 1, wherein the hold down element extends into the compacting chamber a distance of between about one-half inch and about 1.5 inches or less.

5. A cotton packager for forming a compacted body of cotton, comprising:
a packager structure including a floor and a pair of opposing side walls extending upwardly from peripheral edges of the floor defining a cotton compacting chamber, the side walls extending convergingly in an upward direction;
compacting apparatus disposed in an upper region of the chamber and movable downwardly toward the floor for compacting cotton against the floor and the side walls for forming a compacted cotton body therein; and
a vertically spaced array of elongate hold down elements substantially extending along the forward to rearward length of each side walls in substantially parallel relation to the floor, each of the hold down elements projecting from the side wall into the chamber in a position for engaging cotton compacted against the side wall by the compacting apparatus for limiting upward spring back of tile compacted cotton.

6. The cotton packager of claim 5, wherein each of the elongate hold down elements is L-shaped and includes a leg which extends into the chamber, and a leg mounted on the side wall.

7. The cotton packager of claim 5, wherein the hold down elements extend into the compacting chamber by a distance of between about one-half inch and about 1.5 inches.

8. The cotton packager of claim 5, wherein the packager structure further includes an open end enclosed by a door openable for allowing removal of a compacted body of cotton from the cotton compacting chamber.

9. The cotton packager of claim 5, wherein the packager structure includes an end wall extending substantially between the opposing side walls enclosing an end of the compacting chamber opposite of an end from which a compacted body of cotton is to be removed from the chamber, and a vertically spaced array of elongate hold down elements extending along the end wall generally between the side walls in substantially parallel relation to the floor and projecting into the chamber for engaging cotton compacted against the end wall for limiting upward spring back of the compacted cotton.

10. A cotton packager, comprising:
a floor and at least a pair of opposing side walls extending upwardly from peripheral edges of the floor defining a cotton compacting chamber, and a door enclosing an end of the chamber;
compacting apparatus disposed above or in an upper region of the chamber for movement downwardly into the chamber for compacting cotton therein into a compacted body having a shape and sideward extent at least generally defined by the opposing side walls, the door being openable to allow movement of a compacted body of cotton in a direction toward the end and through the end from the chamber; and
at least one elongate hold down element on at least one of the side walls, the hold down element disposed on the side wall so as to substantially extend along the forward to rearward length thereof, the hold down element extending from the side wall into the chamber longitudinally in the direction of movement, for limiting upward movement of cotton compacted by the compacting apparatus.

11. The packager of claim 10, wherein the hold down element has an L-shape including a leg which extends into the chamber.

12. The packager of claim 10, wherein the side walls each include a plurality of the elongate hold down elements extending therealong in a vertically spaced array.

13. The packager of claim 10, wherein the hold down element extends into the compacting chamber a distance of between about one-half inch and about 1.5 inches or less.

14. The packager of claim 10, further comprising an end wall opposite of the end of the chamber enclosed by the door, and at least one elongate hold down element on the end wall for limiting upward movement of cotton along the end wall.

15. The packager of claim 1, wherein the at least one elongate hold down element has a first leg and a second leg, the first leg is disposed along the at least one side wall, the second leg extends from the side wall into the chamber slightly downward toward the distal end thereof along the length thereof.

16. The packager of claim 1, wherein the at least one elongate hold down element has a first leg and a second leg, wherein distal ends of the first and second legs are coupled to the at least one side, wall such that the proximal ends of the first and second legs extend into the chamber and join at an intersecting point.
